(19) United States
(12) Patent Application Publication
(10) Pub. No.: US 2011/0224332 A1
(43) Pub. Date: Sep. 15, 2011

(54) THERMOSETTING RESIN COMPOSITION AND USE THEREOF

(76) Inventors: Yufang He, Humen Town (CN); Lunqiang Zhang, Humen Town (CN)

(21) Appl. No.: 12/479,204

(22) Filed: Jun. 5, 2009

(51) Int. Cl. C08L 63/00; C08K 5/03; C08K 3/36

(52) U.S. Cl. 523/456; 523/400; 523/462; 523/467

(57) ABSTRACT

The present invention discloses a thermosetting resin composition comprising: a bifunctional or multifunctional epoxy resin, a styrene-maleic anhydride (SMA) copolymer with a styrene/maleic anhydride molar ratio of 5-12:1 as a curing agent, a BPA epoxy resin with a low or high bromine content or tetrabromobisphenol A as a flame retardant agent, an accelerator and a solvent. The cured resin composition of the invention has a very low dielectric property, improved thermal reliability and better toughness. A copper clad laminate made of the resin composition and a reinforced material such as glass fiber cloth has a very low dielectric constant and dissipation factor, high Td, better toughness and PCB manufacturability, and thus very suitable to be used as a copper clad laminate and a prepreg for manufacturing PCBs and also applied to the common use of epoxy resins, such as molding resins, and composite materials for construction, automobiles and aviation.

### BACKGROUND OF THE INVENTION

(a) Field of the Invention

The present invention relates to a thermosetting resin composition applicable for manufacturing a copper clad laminate and a prepreg for printed circuit boards (PCBs), and applied to the common use of epoxy resins, such as molding resins, and composite materials for construction, automobiles and aviation.

(b) Description of the Prior Art

Epoxy resins have been used extensively in various types of electronic insulating materials, mainly because they have better thermal resistance, chemical resistance, and good insulating and dielectric properties. Commonly used curing agents include amines, anhydrides and phenols or phenolic aldehydes. Particularly in the applications of copper clad laminates, dicyandiamides (amines) and phenolic resins (phenolic aldehydes) often serve as epoxy resin curing agents and come with better manufacturability, thermal resistance, chemical resistance and insulating property. However, their dielectric properties cannot satisfy the comprehensive requirements for high-frequency signal transmission due to the higher dielectric constants (abbreviated as Dk) and dissipation factors (abbreviated as Df). Particularly in the high frequency (2 GHz and greater) communication field of radio frequency base stations, radar antennas and the like, it sets up higher requirements for signal transmission loss and signal transmission delay. The signal transmission loss is mainly associated with the dielectric loss of materials. The less the dielectric loss is, the less the signal transmission loss becomes. The signal transmission delay is mainly associated with the dielectric constants of materials. The smaller the dielectric constant is, the less the signal transmission delay becomes. As a result, only materials having a particularly low dielectric constant and particularly low dielectric loss can satisfy the application in the high frequency (particularly greater than 10 GHz) communication field. For example, the Dk/Df of polytetrafluoroethylene (PTFE) is approximately 2.1/0.0004 at a frequency of 1 MHz, and the Dk/Df of polyphenylene ether (PPE) is approximately 2.45/0.0007 at a frequency of 1 MHz. Copper clad laminates made of PTFE or PPE have been applied in the high frequency communication field but with high costs, and poor copper clad laminate and PCB manufacturability.

The use of a styrene-maleic anhydride copolymer (abbreviated as SMA) in place of a cured epoxy resin from dicyandiamide and a phenolic resin can avoid the generation of polar OH groups, thereby significantly reducing the dielectric constant and loss of a cured resin. Nevertheless, current technology is limited to the use of SMA copolymers with an S (styrene)/MA (maleic anhydride) molar ratio of 1:1 to 4:1. In the molecular structure, the proportion of styrene which exhibits a low dielectric property is not high enough, so the Dk and Df are not low enough. The Dk and Df of a copper clad laminate made of the aforementioned copolymer and E-glass lie in a range of 3.7-4.2 and a range of 0.008-0.012 at a frequency of 1 GHz, respectively. For instance, a copper clad laminate made of the SMA/epoxy resin composition disclosed in WO9818845, WO9607683, CN1935896A, CN1955217A or CN1955219A has an insufficiently low dielectric property, and its Dk/Df generally falls in the range of 3.7-4.2/0.008-0.012. The SMA/epoxy resin compositions disclosed in other patents have poor PCB manufacturability, unsuitable for the PCB application, or give lower thermal resistance with decreasing Tg and Td.

In view of the foregoing shortcomings of the resin compositions or materials, the present invention discloses a novel resin composition in which the S/MA molar ratio of the SMA copolymer rises to 5-12 so as to increase the proportion of styrene which exhibits a low dielectric property. This can further reduce the Dk and Df of the entire composition. The Dk/Df of a copper clad laminate made of the resin composition and E-glass can reach 3.2-3.6/0.002-0.007 at a frequency of 1 GHz. The resin composition has a lower cost, better PCB manufacturability, improved thermal reliability and low water absorptivity, and completely satisfies the application in the high frequency (particularly greater than 10 GHz) communication field.

### SUMMARY OF THE INVENTION

It is an object of the present invention to provide a thermosetting resin composition that ensures a very low dielectric property, a lower cost, better PCB manufacturability, improved thermal reliability and low water absorptivity.

To achieve the foregoing object, the present invention provides a thermosetting resin composition comprising: a bifunctional or multifunctional epoxy resin, a styrene-maleic anhydride (SMA) copolymer with a styrene/maleic anhydride molar ratio up to 5-12:1 as a curing agent, a BPA epoxy resin with a low or high bromine content or tetrabromobisphenol A (TBBPA or TBBA) as a flame retardant agent, an appropriate accelerator and a solvent.

The epoxy resin is a BPA, BPF, bisphenol-S (abbreviated as BPS) or alkyl substituted bisphenol diglycidyl ether, a phenol novolac epoxy (abbreviated as PNE), o-cresol novolac epoxy (abbreviated as CNE), bisphenol-A novolac epoxy (abbreviated as BNE), resorcinol-formaldehyde epoxy resin, a glycidyl amine epoxy resin obtained by the reaction of a polyamine such as diaminodiphenylmethane or isocyanuric acid with epichlorohydrin, a phenolic/alkyl glycidyl ether epoxy resin of triphenol methane triglycidyl ether, an epoxy resin of a polycondensed resin of dicyclopentadiene or cyclopentadiene and a phenol, an isocyanate-modified epoxy resin, an epoxy resin having a naphthalene ring, a hydantoin epoxy resin, a terpene-modified epoxy resin, a 9,10-dihydro-9-oxa-10-phosphaphenanthrene-10-oxide (abbreviated as DOPO) or a 9,10-dihydro-9-oxa-10-(2′,5′-dihydroxyphenyl)phosphaphenanthrene-10-oxide (abbreviated as DOPO-HQ) modified phosphor-containing epoxy resin, and the epoxy resins can be used individually or in any combination.

The SMA with a high styrene/maleic anhydride molar ratio acts as an epoxy resin curing agent in the resin system for introducing a styrene structure with a good dielectric property into a crosslinked structure to achieve a low Dk and Df. The more the proportion of styrene, the lower the Dk and Df. The SMA of a too high molecular weight (in general, Mw higher than 60000) has a poor compatibility with the epoxy, and the weight percentage content of the anhydride is lower (generally lower than 3%), and thus such SMA is not suitable to be used as the epoxy resin curing agent in the application of manufacturing SMA/epoxy printed circuit boards. Experiments show that SMA with a weight average molecular weight (Mw) in the range from about 10000 to 60000 and in which the weight percentage content of the anhydride is more than about 3% can be used as an epoxy resin curing agent for manufacturing printed circuit boards. Particularly, when SMA and its mixture with a molecular weight (Mw) in the range from about 11000 to 18000 and with a styrene (S): maleic anhydride (MA) molar ratio of 5:1, 6:1, 8:1 to 12:1, such as SMA EF-60 and SMA EF-80 of Sartomer Company are used for manufacturing printed circuit boards, they offer good thermal reliability and a very low dielectric property, as well as excellent manufacturability for printed circuit boards. In the case that the SMA is used as an epoxy resin curing agent in the manufacture of printed circuit boards, the equivalence ratio (anhydride in the SMA and phenoxy group: epoxy resin) is preferably in the range of 0.6:1 to 1.6:1, most preferably in the range of 0.9:1 to 1.1:1.

The aforementioned flame retardant agent includes a low-bromine-content BPA epoxy resin, such as a common FR-4 epoxy resin (e.g. BET-535), a high-bromine-content BPA epoxy resin, such as BET-400, or tetrabromobisphenol A with a higher bromine content (abbreviated as TBBPA or TBBA) that can react with the SMA or the epoxy resin to form a crosslinked structure and achieve a better flame retardance. Besides, they would not affect the reliability including the thermal reliability of cured polymers. Moreover, an additive bromine flame retardant agent, such as ethylenebistetrabromophthalimide (Trade name: SAYTEX BT-93) is partially added to synergistically achieve an improved flame retardant effect and has a chemical structural formula as follows:

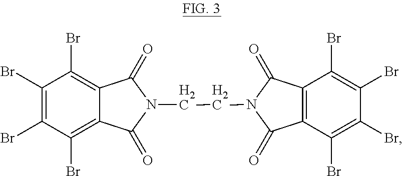

Ethane-1,2-bis(pentabromophenyl) (Trade Name: SAYTEX 8010) has a chemical structural formula as follows:

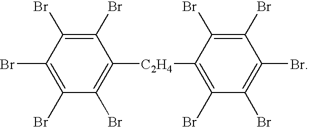

The accelerator used in the present invention is a commonly used imidazole accelerator, particularly an alkyl substituted imidazole, such as 2-methyl-imidazole, 2-ethyl-4-methyl-imidazole, 2-phenyl-imidazole, 2-ethyl-4-phenyl-imidazole and the like. Suitable accelerators for use in the present invention also include various primary, secondary and quaternary amines, quaternary ammonium salts or phosphamidon salts, such as benzyldimethylamine (BDMA), butyltriphenylphosphonium bromide and 4,4′- and 3,3′-diaminodiphenyl sulfone. Other suitable accelerators include peroxide initiators (such as tert-butyl perbenzoate, TBPB), azo initiators (such as azodiisobutyronitrile) and organic metal salts or complexes (such as zinc acetate). The above accelerators can be used in combination with a Lewis acid to speed up the curing reaction. The accelerator is used in a proportion of 0.001-5%, preferably 0.01-2% with respect to the epoxy resin.

The solvent used in the present invention may be one selected from a ketone solvent (such as acetone, methyl ethyl ketone, and cyclohexanone), an aromatic solvent (such as toluene), an alcohol ether solvent (such as propylene glycol monomethyl ether), or a mixture of the above.

In order to increase the toughness of the resin composition of the present invention, allylphenol is often added into the resin composition of the present invention. Allylphenol is a phenol with an allyl group substituted at the ortho-, para- or meta-position of a benzene ring, such as 2,4,6-triallylphenol, diallyl bisphenol A (abbreviated as DABPA), and it has a chemical structural formula as follows:

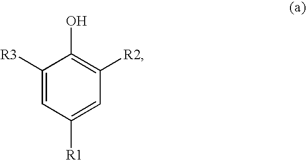

R1, R2, R3: —H, —CH₂—CH═CH₂, —CH₃ (at least one of the R1, R2 and R3 is —CH₂—CH═CH₂),

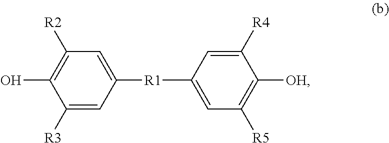

R2, R3, R4, R5: —H, —CH₂—CH═CH₂, —CH₃ (at least one of the R2, R3, R4 and R5 is —CH₂—CH═CH₂),

the R1 has a structural formula as follows:

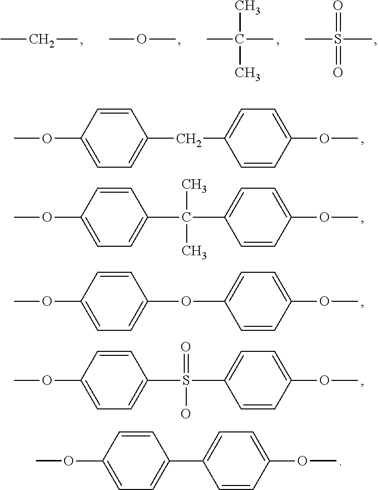

The phenoxy group of the allylphenol can react with the epoxy group of the epoxy resin to produce a crosslinked structure, while the allyl groups are self-polymerized at a high temperature in the presence of a specific initiator to form a crosslinked structure. This crosslinked structure reacts with the crosslinked structure made from the hydroxyl group in the allylphenol, the anhydride in the SMA and the epoxy group to form an interpenetrating network (IPN), such that the final polymer has better toughness due to the addition of the allyl polymer network. Since the allylphenol is involved in chemical crosslinking to maintain the polymer's original thermal reliability and other excellent properties.

In addition to allylphenol, allyl ester is often added into the resin composition of the present invention as a toughening agent to increase the toughness of the resin composition. For example, triallyl cyanurate (abbreviated as TAC) and triallyl isocyanurate (abbreviated as TAIC) are two commonly used allyl esters. Further, allyl ether is often added into the resin composition of the present invention to increase the toughness of the composition. While the allyl ether does not have groups directly reactive with the epoxy groups, the allyl ethers can be self-polymerized through their double bonds and can form an IPN structure with the crosslinked epoxy structure to achieve a better toughening effect. The aforementioned allyl ether is obtained after an allyl alcohol and an ortho-, para- or meta-substituted phenol are polycondensed, such as 2,4,6-triallylphenol ether, diallyl bisphenol A ether, and it has a chemical structural formula as follows:

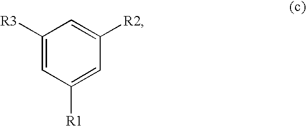

R1, R2, R3: —H, —CH₂—CH═CH₂, —CH₃ (at least one of the R1, R2 and R3 is —CH₂—CH═CH₂),

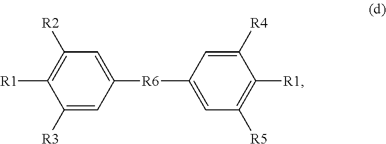

R2, R3, R4, R5: —H, —CH₂—CH═CH₂, —CH₃ (at least one of the R2, R3, R4 and R5 is —CH₂—CH═CH₂),

the R6 has a structural formula as follows:

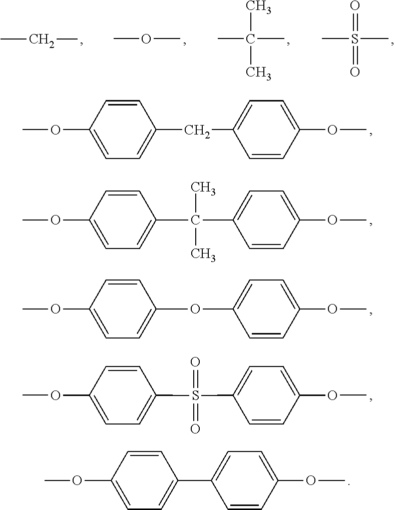

In order to increase the glass transition temperature (hereinafter abbreviated as Tg) of the resin composition of the present invention, a portion of a cyanate ester (such as bisphenol A cyanate ester, BA-230S) or a polyimide resin of bismaleimide are usually added into the resin composition of the present invention to result in a higher crosslinking density, thereby increasing Tg by 20-40° C.

The rubber or rubber modified compound can be a rubber modified epoxy resin such as styrene/butadiene copolymer, a copolymer of butadiene/styrene and methyl methacrylate or other vinyl compound, polymethyl methacrylate/butadiene/styrene rubber core-shell particles or their modified epoxy resin or phenolic resin, polydimethylsiloxane core-shell particles or their modified epoxy resin or phenolic resin, CTBN, and works together with allylphenol to increase the toughness of the resin composition. The toughening agent of the resin composition of the present invention further comprises an ether condensed from allylphenol, such as diallyl bisphenol A ether.

The resin composition of the present invention further comprises an appropriate filler for lowering the expansion coefficient of the resin composition in the manufacture of printed circuit boards, and the filler can be silicon dioxide (including crystalline, melted, hollow and spherical silicon dioxide), aluminum oxide, mica, talcum powder, boron nitride, aluminum nitride, silicon carbide, diamond, calcined clay, aluminum oxide, aluminum nitride fiber, glass fiber, or any combination of the above.

The resin composition of the present invention further comprises an additive such as a defoaming agent, a coupling agent, a leveling agent, a dye, and a pigment, etc.

According to the present invention, a copolymer of an unsaturated anhydride having olefinic double bonds and a vinyl compound (such as a styrene-maleic anhydride copolymer) is used as a curing agent in which the proportion of vinyl compound in the molecular structure is relatively high. This can achieve a very low Dk and Df effectively and thus can improve the dielectric property, while effectively achieving lower water absorptivity and higher thermal resistance.

The cured resin composition of the present invention has a very good dielectric property, better thermal reliability and toughness. A copper clad laminate made of the resin composition and a reinforced material such as glass fiber cloth has a very low dielectric constant (abbreviated as Dk) and dissipation factor (abbreviated as Df), high Tg, high thermal decomposition temperature (abbreviated as Td), better toughness and good PCB manufacturability. Therefore, the resin composition of the present invention is very suitable to be used as a copper clad laminate and a prepreg for manufacturing PCBs.

In addition, due to the excellent dielectric property, high thermal reliability and better toughness, it can be applied to the common use of epoxy resins, such as molding resins, and composite materials for construction, automobiles and aviation.

### DETAILED DESCRIPTION OF THE PREFERRED EMBODIMENTS

Now, the implementation method is described below. The ingredients such as resins and solvents are mixed with stirring into a uniform resin solution. Then, 2116 glass cloth is dipped into the uniformly mixed resin solution and baked at 170° C. for 5 minutes to dry the solvent and form a prepreg. 8 sheets of 2116 prepreg with upper and lower 1 oz HTE copper foils are put together into a vacuum hot press and cured at a high temperature. It is ensured that the curing is carried out under the curing condition of over 190° C. for over 100 minutes, and the high curing pressure is 350 PSI. The physical and electrical properties of the copper clad laminate are determined according to the testing method of IPC-TM-650 standard. The implementation method is used in all the following examples.

The following examples are provided for illustration only, but not intended for limiting the scope of the invention.

### EXAMPLES 1-5

If the ratio of the equivalents of anhydride and phenoxy groups to the epoxy equivalents varies, the properties, such as Tg, of the copper clad laminate made of the resin composition in accordance with the aforementioned experiment method will vary accordingly. The variation of Tg is listed in Table 1. If the equivalence ratio is in 0.9:1.0 to 1.1:1, the Tg of the copper clad laminate will be maximized.

TABLE 1

| Example No. | | | | |
|---|---|---|---|---|
| 1 | 2 | 3 | 4 | 5 |

| | | | | | |
|---|---|---|---|---|---|
| equivalents of anhydride and | 1.6 | 1.3 | 1.1 | 0.9 | 0.6 |
| phenoxy groups | | | | | |
| epoxy equivalents | 1 | 1 | 1 | 1 | 1 |
| Tg (DSC) (° C.) | 131 | 138 | 149 | 142 | 133 |

Note:
(1) The proportion of each ingredient listed in the table is calculated in terms of solid content.
(2) The molar ratio of S:MA in the SMA is 8:1 and is hereinafter represented by SMA (S:MA = 8:1).

### EXAMPLE 6 (COMPARATIVE)

A resin composition is prepared according to the following formula: Firstly, 192 g of methyl ethyl ketone (MEK) solvent is used to dissolve 156 g of SMA3000 and 40 g of TBBA, and then 185 g of BET-535A80 (with 80% of a solid content and 20% of acetone solvent) and 93.3 g of BET-400T60 (with 60% of a solid content and 40% of toluene solvent) are added, and 0.12 g of 2-ethyl-4-methyl-imidazole (abbreviated as 2E4Mz) is added, and the mixture is uniformly mixed with stirring for 2 hours. A copper clad laminate is produced in accordance with the aforementioned method and its physical and electrical properties are tested. In this example, the ratio of the sum of the equivalents of anhydride and phenoxy group to the epoxy equivalents of is 1.1:1.

### EXAMPLE 7

A resin composition is prepared according to the following formula: Firstly, 272 g of methyl ethyl ketone (MEK) solvent is used to dissolve 220 g of SMA (S:MA=5:1) and 20 g of TBBA, and then 25 g of BET-535A80 (with 80% of a solid content and 20% of acetone solvent) and 233.3 g of BET-400T60 (with 60% of a solid content and 40% of toluene solvent) are added, and 0.36 g of 2-ethyl-4-methyl-imidazole (abbreviated as 2E4Mz) is added, and the mixture is uniformly mixed with stirring for 2 hours. A copper clad laminate is produced in accordance with the aforementioned method and its physical and electrical properties are tested. In this example, the ratio of the sum of the equivalents of anhydride and phenoxy group to the epoxy equivalents is 1.1:1.

### EXAMPLE 8

A resin composition is prepared according to the following formula: Firstly, 280 g of methyl ethyl ketone solvent is used to dissolve 232 g of SMA (S:MA=6:1) and 20 g of TBBA, and then 25 g of BET-535A80 (with 80% of a solid content and 20% of acetone solvent) and 213.3 g of BET-400T60 (with 60% of a solid content and 40% of toluene solvent) are added, and 0.52 g of 2E4Mz is added, and the mixture is uniformly mixed with stirring for 2 hours. A copper clad laminate is produced in accordance with the aforementioned method and its physical and electrical properties are tested. In this example, the ratio of the sum of the equivalents of anhydride and phenoxy group to the epoxy equivalents is 1.1:1.

### EXAMPLE 9

A resin composition is prepared according to the following formula: Firstly, 292 g of methyl ethyl ketone solvent is used to dissolve 252 g of SMA (S:MA=8:1) and 20 g of TBBA, and then 25 g of BET-535A80 (with 80% of a solid content and 20% of acetone solvent) and 180 g of BET-400T60 (with 60% of a solid content and 40% of toluene solvent) are added, and 0.8 g of 2E4Mz is added, and the mixture is uniformly mixed with stirring for 2 hours. A copper clad laminate is produced in accordance with the aforementioned method and its physical and electrical properties are tested. In this example, the ratio of the sum of the equivalents of anhydride and phenoxy group to the epoxy equivalents is 1.1:1.

### EXAMPLE 10

A resin composition is prepared according to the following formula: Firstly, 304 g of methyl ethyl ketone solvent is used to dissolve 266 g of SMA (S:MA=10:1) and 20 g of TBBA, and then 25 g of BET-535A80 (with 80% of a solid content and 20% of acetone solvent) and 156.7 g of BET-400T60 (with 60% of a solid content and 40% of toluene solvent) are added, and 1.0 g of 2E4Mz is added, and the mixture is uniformly mixed with stirring for 2 hours. A copper clad laminate is produced in accordance with the aforementioned method and its physical and electrical properties are tested. In this example, the ratio of the sum of the equivalents of anhydride and phenoxy group to the epoxy equivalents is 1.1:1.

### EXAMPLE 11

A resin composition is prepared according to the following formula: Firstly, 316 g of methyl ethyl ketone solvent is used to dissolve 300 g of SMA (S:MA=12:1), and then 15 g of BET-535A80 (with 80% of a solid content and 20% of acetone solvent) and 133.3 g of BET-400T60 (with 60% of a solid content and 40% of toluene solvent) are added, and 1.2 g of 2E4Mz is added, and the mixture is uniformly mixed with stirring for 2 hours. A copper clad laminate is produced in accordance with the aforementioned method and its physical and electrical properties are tested. In this example, the ratio of the sum of the equivalents of anhydride and phenoxy group to the epoxy equivalents is 1.1:1.

### EXAMPLE 12

A resin composition is prepared according to the following formula: Firstly, 328 g of methyl ethyl ketone solvent is used to dissolve 252 g of SMA (S:MA=8:1) and 20 g of TBBA, and then 25 g of BET-535A80 (with 80% of a solid content and 20% of acetone solvent), 180 g of BET-400T60 (with 60% of a solid content and 40% of toluene solvent) and 40 g of TAC are added, and 0.4 g of tert-butyl perbenzoate and 0.8 g of 2E4Mz are added, and the mixture is uniformly mixed with stirring for 2 hours. A copper clad laminate is produced in accordance with the aforementioned method and its physical and electrical properties are tested. In this example, the ratio of the sum of the equivalents of anhydride and phenoxy group to the epoxy equivalents is 1.1:1.

### EXAMPLE 13

A resin composition is prepared according to the following formula: Firstly, 296 g of methyl ethyl ketone solvent is used to dissolve 240 g of SMA (S:MA=8:1) and 8 g of TBBA, and then 25 g of BET-535A80 (with 80% of a solid content and 20% of acetone solvent), 220 g of BET-400T60 (with 60% of a solid content and 40% of toluene solvent) and 20 g of DABPA are added, and 0.2 g of tert-butyl perbenzoate and 0.8 g of 2E4Mz are added, and the mixture is uniformly mixed with stirring for 2 hours. A copper clad laminate is produced in accordance with the aforementioned method and its physical and electrical properties are tested. In this example, the ratio of the sum of the equivalents of anhydride and phenoxy group to the epoxy equivalents is 1.1:1.

### EXAMPLE 14

A resin composition is prepared according to the following formula: Firstly, 312 g of methyl ethyl ketone solvent is used to dissolve 252 g of SMA (S:MA=8:1) and 20 g of TBBA, and then 25 g of BET-535A80 (with 80% of a solid content and 20% of acetone solvent), 180 g of BET-400T60 (with 60% of a solid content and 40% of toluene solvent) and 20 g of diallyl bisphenol A ether are added, and 0.2 g of tert-butyl perbenzoate and 0.8 g of 2E4Mz are added, and the mixture is uniformly mixed with stirring for 2 hours. A copper clad laminate is produced in accordance with the aforementioned method and its physical and electrical properties are tested. In this example, the ratio of the sum of the equivalents of anhydride and phenoxy group to the epoxy equivalents is 1.1:1.

### EXAMPLE 15

A resin composition is prepared according to the following formula: Firstly, 312 g of methyl ethyl ketone solvent is used to dissolve 252 g of SMA (S:MA=8:1) and 20 g of TBBA, and then 25 g of BET-535A80 (with 80% of a solid content and 20% of acetone solvent), 180 g of BET-400T60 (with 60% of a solid content and 40% of toluene solvent) and 20 g of polymethyl methacrylate/butadiene/styrene core-shell particles are added, and 0.2 g of tert-butyl perbenzoate and 0.8 g of 2E4Mz are added, and the mixture is uniformly mixed with stirring for 2 hours. A copper clad laminate is produced in accordance with the aforementioned method and its physical and electrical properties are tested. In this example, the ratio of the sum of the equivalents of anhydride and phenoxy group to the epoxy equivalents is 1.1:1.

### EXAMPLE 16

A resin composition is prepared according to the following formula: Firstly, 288 g of methyl ethyl ketone solvent is used to dissolve 248 g of SMA (S:MA=8:1) and 8 g of TBBA, and then 25 g of BET-535A80 (with 80% of a solid content and 20% of acetone solvent), 180 g of BET-400T60 (with 60% of a solid content and 40% of toluene solvent) and 21.3 g of BA-230S (with 75% of a solid content and 25% of methyl ethyl ketone solvent) are added, and 0.08 g of zinc acetate and 0.8 g of 2E4Mz are added, and the mixture is uniformly mixed with stirring for 2 hours. A copper clad laminate is produced in accordance with the aforementioned method and its physical and electrical properties are tested. In this example, the ratio of the sum of the equivalents of anhydride and phenoxy group to the epoxy equivalents is 1.3:1.

### EXAMPLE 17

A resin composition is prepared according to the following formula: Firstly, 288 g of methyl ethyl ketone solvent is used to dissolve 248 g of SMA (S:MA=8:1) and 8 g of TBBA, and then 25 g of BET-535A80 (with 80% of a solid content and 20% of acetone solvent), 180 g of BET-400T60 (with 60% of a solid content and 40% of toluene solvent) and 21.3 g of BA-230S (with 75% of a solid content and 25% of methyl ethyl ketone solvent) are added, and 0.08 g of zinc acetate and 0.8 g of 2E4Mz are added, and finally 100 g of melted silicon dioxide is added, and the mixture is uniformly mixed with stirring for 2 hours. A copper clad laminate is produced in accordance with the aforementioned method and its physical and electrical properties are tested. In this example, the ratio of the sum of the equivalents of anhydride and phenoxy group to the epoxy equivalents is 1.3:1.

The proportions of the resin composition in EXAMPLES 6-17 and the properties of the copper clad laminates made of the resin compositions are shown in Table 2. Compared with COMPARATIVE EXAMPLE 6, the Dks and Dfs in EXAMPLES 7 to 11 are apparently lower and decrease with the increase of the proportion of styrene in the SMA (from S:MA=5:1 to S:MA=12:1), to a range of 3.2-3.6 and a range of 0.002-0.007, respectively. In EXAMPLES 12 to 15, the addition of TAC, DABPA, diallyl bisphenol A ether and/or polymethyl methacrylate/butadiene/styrene core-shell particles can significantly improve the toughness of the composition so as to improve the peel strength, while the thermal resistance remains at a high level. In EXAMPLE 16, a certain level of cyanate ester is added so that the Tg significantly increases in comparison with EXAMPLE 9. In EXAMPLE 17, because a certain ratio of an inorganic filler is added, the Z-axis CTE is significantly less than that in EXAMPLE 16. According to the present invention, a copper clad laminate made of the SMA epoxy resin composition with an S:MA molar ratio of 5:1 to 12:1 has a lower cost, a very low Dk and Df, better thermal resistance and PCB manufacturability. Therefore, the thermosetting resin composition is suitable for high frequency PCB application.

TABLE 2

| | Example No. | | | | | |
|---|---|---|---|---|---|---|
| | 6 (Comparative) | 7 | 8 | 9 | 10 | 11 |
| BET-535 | 37 | 5 | 5 | 5 | 5 | 3 |
| TBBA | 10 | 5 | 5 | 5 | 5 | 2 |
| BET-400 | 14 | 35 | 32 | 27 | 23.5 | 20 |
| SMA3000 | 39 | / | / | / | / | / |
| (or EF-30) | | | | | | |
| SMA (S:MA = 5:1) | / | 55 | / | / | / | / |
| SMA (S:MA = 6:1) | / | / | 58 | / | / | / |
| SMA (S:MA = 8:1) | / | / | / | 63 | / | / |
| SMA (S:MA = 10:1) | / | / | / | / | 66.5 | / |
| SMA (S:MA = 12:1) | / | / | / | / | / | 75 |
| TAC | / | / | / | / | / | / |
| DABPA | / | / | / | / | / | / |
| diallyl bisphenol A | / | / | / | / | / | / |
| ether | | | | | | |
| polymethyl | / | / | / | / | / | / |
| methacrylate/ | | | | | | |
| butadiene/styrene | | | | | | |
| core-shell particles | | | | | | |
| BA-230S | / | / | / | / | / | / |
| melted silicon | / | / | / | / | / | / |
| dioxide | | | | | | |
| 2E4Mz | 0.03 | 0.05 | 0.13 | 0.20 | 0.25 | 0.30 |
| tert-butyl | / | / | / | / | / | / |
| perbenzoate | | | | | | |
| zinc acetate | / | / | / | / | / | / |
| Tg (DSC)(° C.) | 181 | 172 | 161 | 149 | 141 | 129 |
| Td (5% wt. loss)(° C.) | 361 | 359 | 362 | 363 | 364 | 366 |
| peel strength (lb/in) | 6.5 | 5.85 | 5.53 | 4.51 | 4.33 | 3.85 |
| Dk (100 MHz) | 3.69 | 3.59 | 3.51 | 3.49 | 3.46 | 3.42 |
| Df (100 MHz) | 0.0093 | 0.0058 | 0.0045 | 0.0037 | 0.0032 | 0.0025 |
| a1 (ppm/° C.) | 73 | 71 | 70 | 69 | 68 | 65 |
| bending modulus | 48.4 | 51.2 | 54.3 | 59.1 | 62.3 | 68.1 |
| (GPa) | | | | | | |

| | Example No. | | | | | |
|---|---|---|---|---|---|---|
| | 12 | 13 | 14 | 15 | 16 | 17 |
| BET-535 | 5 | 5 | 5 | 5 | 5 | 5 |
| TBBA | 5 | 2 | 5 | 5 | 2 | 2 |
| BET-400 | 27 | 33 | 27 | 27 | 27 | 27 |
| SMA3000 | / | / | / | / | / | / |
| (or EF-30) | | | | | | |
| SMA (S:MA = 5:1) | / | / | / | / | / | / |
| SMA (S:MA = 6:1) | / | / | / | / | / | / |
| SMA (S:MA = 8:1) | 63 | 60 | 63 | 63 | 62 | 62 |
| SMA (S:MA = 10:1) | / | / | / | / | / | / |
| SMA (S:MA = 12:1) | / | / | / | / | / | / |
| TAC | 10 | / | / | / | / | / |
| DABPA | / | 5 | / | / | / | / |
| diallyl bisphenol A | / | / | 5 | / | / | / |
| ether | | | | | | |
| polymethyl | / | / | / | 5 | / | / |
| methacrylate/ | | | | | | |
| butadiene/styrene | | | | | | |
| core-shell particles | | | | | | |
| BA-230S | / | / | / | / | 4 | 4 |
| melted silicon | / | / | / | / | / | 25 |
| dioxide | | | | | | |
| 2E4Mz | 0.20 | 0.20 | 0.20 | 0.20 | 0.20 | 0.20 |
| tert-butyl | 0.1 | 0.05 | 0.05 | / | / | / |
| perbenzoate | | | | | | |
| zinc acetate | / | / | / | / | 0.02 | 0.02 |
| Tg (DSC)(° C.) | 146 | 151 | 140 | 139 | 160 | 158 |
| Td (5% wt. loss)(° C.) | 362 | 364 | 362 | 358 | 355 | 353 |
| peel strength (lb/in) | 5.46 | 5.67 | 5.54 | 5.95 | 5.35 | 4.82 |
| Dk (100 MHz) | 3.6 | 3.6 | 3.57 | 3.52 | 3.37 | 3.63 |
| Df (100 MHz) | 0.0042 | 0.0042 | 0.0038 | 0.0048 | 0.0036 | 0.0034 |
| a1 (ppm/° C.) | 65 | 71 | 73 | 78 | 58 | 49 |
| bending modulus | 52.4 | 51.4 | 52.1 | 49.5 | 54.3 | 58.2 |
| (GPa) | | | | | | |

Note:
The proportion of each ingredient listed in the table is calculated in terms of solid content, and a1 is the expansion coefficient at Tg.

1. A thermosetting resin composition for making a prepreg for printed circuit boards or a copper clad laminate with a dielectric constant Dₖ and a dissipation factor D_{f}, comprising: a bifunctional or multifunctional epoxy resin, a styrene-maleic anhydride (SMA) copolymer of styrene (S) and maleic anhydride (MA) in a molar ratio S:MA of 5:1, 6:1, 8:1, 10:1, or 12:1, as a curing agent, a BPA epoxy resin with a low or high bromine content or tetrabromobisphenol A as a flame retardant agent, an accelerator and a solvent, wherein both the dielectric constant Dₖ and the dissipation factor D_{f} decrease linearly, respectively, with an increase of styrene (S) in the styrene-maleic anhydride (SMA) copolymer, of which the molar ratio S:MA ranging from 5:1 to 12:1.

2. The thermosetting resin composition as claimed in claim 1, characterized in that the bifunctional or multifunctional epoxy resin is a BPA, BPF, bisphenol-S or alkyl substituted bisphenol diglycidyl ether, a phenol novolac epoxy, o-cresol novolac epoxy, bisphenol-A novolac epoxy, resorcinol-formaldehyde epoxy resin, a glycidyl amine epoxy resin obtained by the reaction of a polyamine of diaminodiphenylmethane or isocyanuric acid with epichlorohydrin, a phenolic/alkyl glycidyl ether epoxy resin of triphenol methane triglycidyl ether, an epoxy resin of a polycondensed resin of dicyclopentadiene or cyclopentadiene and a phenol, an isocyanate-modified epoxy resin, an epoxy resin having a naphthalene ring, a hydantoin epoxy resin, a terpene-modified epoxy resin, a 9, 10-dihydro-9-oxa-10-phosphaphenanthrene-10-oxide or a 9, 10-dihydro-9-oxa-10-(2′, 5′-dihydroxyphenyl) phosphaphenanthrene-10-oxide modified phosphor -containing epoxy resin, and the epoxy resins can be used individually or in any combination.

3. The thermosetting resin composition as claimed in claim 1, characterized in that the SMA has a weight average molecular weight (Mw) in the range from 10000 to 60000, and the weight percentage content of the anhydride is more than about 3%.

4. The thermosetting resin composition as claimed in claim 3, characterized in that the SMA has a molecular weight in the range from 11000 to 18000.

5. The thermosetting resin composition as claimed in claim 1, characterized in that the equivalence ratio of anhydride in the SMA and phenoxy group: epoxy resin is in the range of 0.6:1 to 1.6:1.

6. The thermosetting resin composition as claimed in claim 1, characterized in that the flame retardant agent is one selected from an FE-4 epoxy resin, a high-bromine-content BPA epoxy resin, TBBPA and TBBA, with partial addition of an additive bromine flame retardant agent having a chemical structural formula as follows:

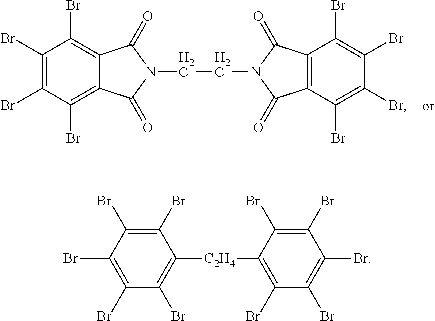

7. The thermosetting resin composition as claimed in claim 1, characterized in that the accelerator is an imidazole accelerator, including an alkyl substituted imidazole selected from the collection of 2-methyl -imidazole, 2-ethyl-4-methyl-imidazole, 2-phenyl -imidazole and 2-ethyl-4-phenyl-imidazole; or a primary, secondary or quaternary amine, a quaternary ammonium salt, or a phosphamidon salt selected from the collection of benzyldimethylamine (BDMA), butyltriphenylphosphonium bromide and 4,4′- and 3,3′-diaminodiphenyl sulfone; or a peroxide initiator, an azo initiator and an organic metal salt or complex; or a Lewis acid; the accelerators can be used individually or in any combination; and the accelerator is used in a proportion of 0.001-5% with respect to the epoxy resin.

8. The thermosetting resin composition as claimed in claim 1, characterized in that the solvent is one selected from the collection of a ketone solvent, an aromatic solvent, an alcohol ether solvent and a mixture of the above.

9. The thermosetting resin composition as claimed in claim 1, characterized in that the resin composition further comprises an allylphenol which is a phenol with an allyl group substituted at the ortho-, para- or meta- position of a benzene ring and has a chemical structural formula as follows: 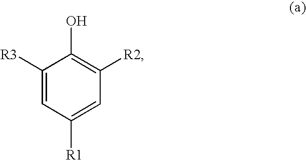
R1, R2, R3: —H, —CH₂—CH═CH₂, —CH₃ (wherein at least one of the R1, R2 and R3 is —CH₂—CH═CH₂), 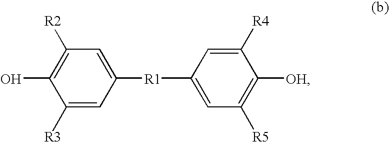
R2, R3, R4, R5: —H, —CH₂—CH═CH₂, —CH₃ (wherein at least one of the R2, R3, R4 and R5 is —CH₂—CH═CH₂), and
the R1 had a structural formula as follows:

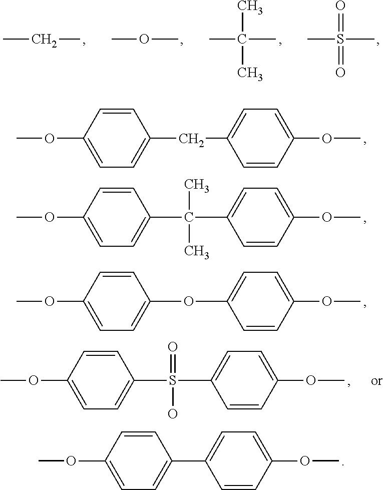

10. The thermosetting resin composition as claimed in claim 1, characterized in that the resin composition further comprises an allyl ether which is an ether obtained after an allyl alcohol and an ortho-, para- or meta-substituted phenol are polycondensed and has a chemical structural formula as follows: 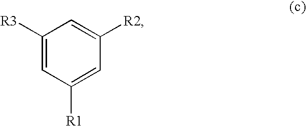
R1, R2, R3: —H, —O—CH₂—CH═CH₂, —CH₃ (wherein at least one of the R1, R2 and R3 is —O—CH₂—CH═CH₂), 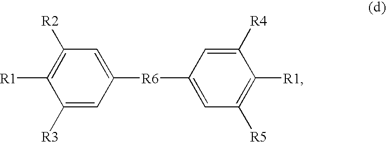
R1: —O—CH₂—CH═CH₂, R2, R3, R4, R5: —H, —CH₂—CH═CH₂, —CH₃, and the R6 has a structural formula as follows:

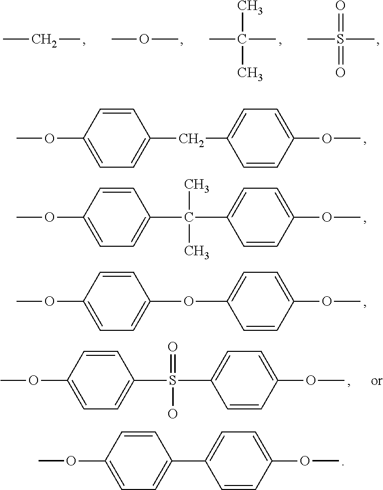

11. The thermosetting resin composition as claimed in claim 1, characterized in that the resin composition further comprises a polyimide resin including cyanate ester or bismaleimide.

12. The thermosetting resin composition as claimed in claim 1, characterized in that the resin composition further comprises a rubber or a rubber modified compound selected from the collection of styrene/butadiene copolymer, butadiene/styrene and methyl methacrylate or other vinyl polymer, methyl methacrylate/butadiene/styrene rubber core-shell particles, modified epoxy resin or phenolic resin, polydimethylsiloxane core-shell particles or their modified epoxy resin or phenolic resin and a rubber modified epoxy resin.

13. The thermosetting resin composition as claimed in claim 1, characterized in that the resin composition further comprises a filler selected from the collection of crystalline, melted, hollow and spherical silicon dioxide, aluminum oxide, mica, talcum powder, boron nitride, aluminum nitride, silicon carbide, diamond, calcined clay, aluminum oxide, aluminum nitride fiber, glass fiber and a mixture of the above.

14. The thermosetting resin composition as claimed in claim 1, characterized in that the resin composition further comprises an additive selected from the collection of a defoaming agent, a coupling agent, a leveling agent, a dye, a pigment, and a mixture of the above.

15. (canceled)
